(19) United States
(12) Patent Application Publication
(10) Pub. No.: US 2024/0243795 A1
(43) Pub. Date: Jul. 18, 2024

(54) OFF-DIAGONAL BEAMFORMING AND FULLY CONNECTED RECONFIGURABLE INTELLIGENT SURFACES

(71) Applicant: InterDigital Patent Holdings, Inc., Wilmington, DE (US)

(72) Inventors: Ibrahim Hemadeh, Hemel Hempstead (GB); Qingchao Li, Southampton (GB); Mohammed El-Hajjar, Southampton (GB); Alain Mourad, Ascot (GB); Arman Shojaeifard, London (GB)

(73) Assignee: InterDigital Patent Holdings, Inc., Wilmington, DE (US)

(21) Appl. No.: 18/562,713

(22) PCT Filed: May 25, 2022
(86) PCT No.: PCT/US2022/030860

§ 371 Date: Nov. 20, 2023

Related U.S. Application Data
(60) Provisional application No. 63/193,906, filed on May 27, 2021.

(51) Int. Cl. H04B 7/06; H04B 7/04

(52) U.S. Cl. CPC H04B 7/0632; H04B 7/04013

(57) ABSTRACT

A reconfigurable intelligent surface (RIS) may include a multi-directional and fully connected load impedance network may be provided. The RIS may include a plurality of elements that are each configured to receive and/or transmit signals. Each element of the RIS may be connected to each of the other elements of the RIS via a multi-directional and fully connected load impedance network. The RIS may receive feedback that comprises channel quality information for a channel between the RIS and another device. The RIS may determine routing information for the RIS based on the feedback. The routing information may comprise a mapping of ingress signals to egress signals. A first signal may be received via an ingress element. The RIS may route and phase shift the first signal to an egress element based on the determined routing information. The RIS may transmit the phase shifted first signal via the second element.

### CROSS REFERENCE TO RELATED APPLICATIONS

This application claims the benefit of U.S. Provisional Patent Application No. 63/193,906, filed May 27, 2021, which is hereby incorporated by reference in its entirety.

### BACKGROUND

The techniques described herein relate to the field of computing and communications and, more particularly, to methods, apparatus, systems, architectures and interfaces for computing and communications in an advanced or next generation wireless communication system, including communications carried out using a new radio and/or new radio (NR) access technology and communication systems. Such NR access and technology, which may also be referred to as 5G and/or 6G, etc., and/or other similar wireless communication systems and technology may include features and/or technologies for a reconfigurable intelligent surface (RIS). As described herein, a RIS may be capable of adapting to radio environment conditions. For example, a RIS may be capable of electronically controlling the propagation of radio frequency (RF) signals impinging on a surface of the RIS.

### SUMMARY

A reconfigurable intelligent surface (RIS) that includes a multi-directional and fully connected load impedance network may be provided (e.g., a multi-direction and fully connected RIS). The RIS may include a plurality of elements, and each of the plurality of elements configured to receive and/or transmit signals. For example, each element of the RIS may be connected to each of the other elements of the RIS via a load impedance network that is configured to provides multi-directional connections between each of the plurality of elements. The RIS may include a controller (e.g., a RIS controller). The RIS controller may receive a first feedback (e.g., from the network) that comprises channel quality information associated with a wireless channel between the RIS and at least one other device (e.g., a transmitter, such as a gNB, or a receiver, such as a WTRU). The RIS controller may determine routing information for the plurality of elements of the RIS based on the first feedback. For example, the routing information may comprise a mapping of ingress signals from each of the plurality of elements to egress signals from each of the other elements of the plurality of elements. A first signal may be received via a first element of the plurality of elements (e.g., an ingress element). The RIS controller may route the first signal to at least a second element of the plurality of elements (e.g., an egress element) based on the determined routing information. For example, the signal may be phase-shifted while being routed from the ingress element to the egress element. The RIS controller may transmit the phase shifted first signal via the second element.

The RIS controller may receive a second feedback that comprises updated channel quality information associated with the wireless channel between the RIS and the at least one other device. The RIS controller may determine updated routing information based on the second feedback. A second signal may be received via the first element. The RIS controller may route the second signal to at least a third element of the plurality of elements based on the determined routing information. For example, the signal may be phase-shifted while being routed from the first element to the third element. The RIS controller may transmit the phase shifted second signal via the third element.

As described herein, the RIS controller may determine routing information based on feedback (e.g., received from a transmitter or a receiver). For example, the RIS controller may determine channel coefficients (e.g., channel coefficients that comprise amplitude components) associated with the wireless channel between the RIS and the device that transmitted the feedback. The RIS controller may sort the determined channel coefficients associated with the wireless channel between the RIS and the device that transmitted the feedback. The determined routing information is further based on the sorted channel coefficients associated with the wireless channel between the RIS and the device that transmitted the feedback.

A wireless transmit/receive unit (WTRU) may be configured to communicate with a RIS/RIS controller. The WTRU may determine channel quality information for a wireless channel associated with the RIS. The WTRU may determine a first feedback information based on the channel quality information. For example, the first feedback may comprise signal routing information and phase shift information. In certain implementations, the signal routing information may comprise an indication that a signal received via a first element of the RIS should be routed to a second element of the RIS for transmission. Similarly, the phase shift information may indicate a phase shift that should be applied to the signal received via the first element of the RIS that is routed to the second element of the RIS for transmission. The WTRU may transmit the first feedback to the RIS (e.g., via the RIS controller). The WTRU may determine second feedback information that comprises updated phase shift information. For example, the updated phase shift information may indicate an updated phase shift that should be applied in accordance with the routing information comprised in the first feedback. The WTRU may transmit the second feedback to the RIS controller.

In certain implementations, the WTRU may periodically determine updated phase shift information based on signals received from the RIS, and the updated phase shift information may indicate phase shifts that should be applied to the signals received via the first element. The WTRU may periodically transmit the updated phase shift information to the RIS. Also, or alternatively, the WTRU may periodically determine updated signal routing information based on signals received from the RIS. For example, the updated signal routing information may comprise an indication that signals received via the first element of the RIS should be routed to a third element of the RIS for transmission. The WTRU may periodically transmit the updated signal routing information to the RIS. The updated phase shift information may periodically transmitted to the RIS more frequently than the updated routing information to the RIS is periodically transmitted to the RIS.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example RIS-aided wireless system;

FIG. 3 illustrates an example 4×4 RIS array with single load impedance;

FIG. 4 illustrates an example associated with RIS beamforming;

FIG. illustrates another example 4×4 RIS array design;

FIG. 6 illustrates an example fully connected and multi-directional RIS array;

FIG. 7 illustrates an example fully-connected multi-directional RIS that may employ off-diagonal beamforming techniques;

FIG. 8 illustrates an example associated with a RIS-aided single-user system;

FIG. 9 illustrates an example message flow associated with transmitter-centric off-diagonal beamforming techniques;

FIG. 10 illustrates an example message flow associated with RIS controller-centric off-diagonal beamforming techniques;

FIG. 11 illustrates an example associated with off-diagonal beamforming techniques;

FIG. 12 illustrates an example power gain comparison;

FIG. 13 illustrates an example bit error rate (BER) performance comparison;

FIG. 14 illustrates an example associated with channel sorting techniques;

FIG. 15 illustrates an example associated with ingress and egress channel elements of a RIS;

FIG. 16 illustrates an example 3-element RIS that may employ multi-directional signal routing;

FIG. 17 illustrates an example associated with a RIS-aided multiple inputs single output (MISO) system;

FIG. 18 illustrates an example comparison of achievable rates versus a number of RIS elements N;

FIG. 19 illustrates an example associated with a RIS-aided multiple input multiple output (MIMO) system;

FIG. 20 illustrates an example associated with a multi-user (MU) RIS-aided MIMO system; and

FIG. 21 illustrates an example comparison of achievable rates versus the number of RIS elements, N.

### DETAILED DESCRIPTION

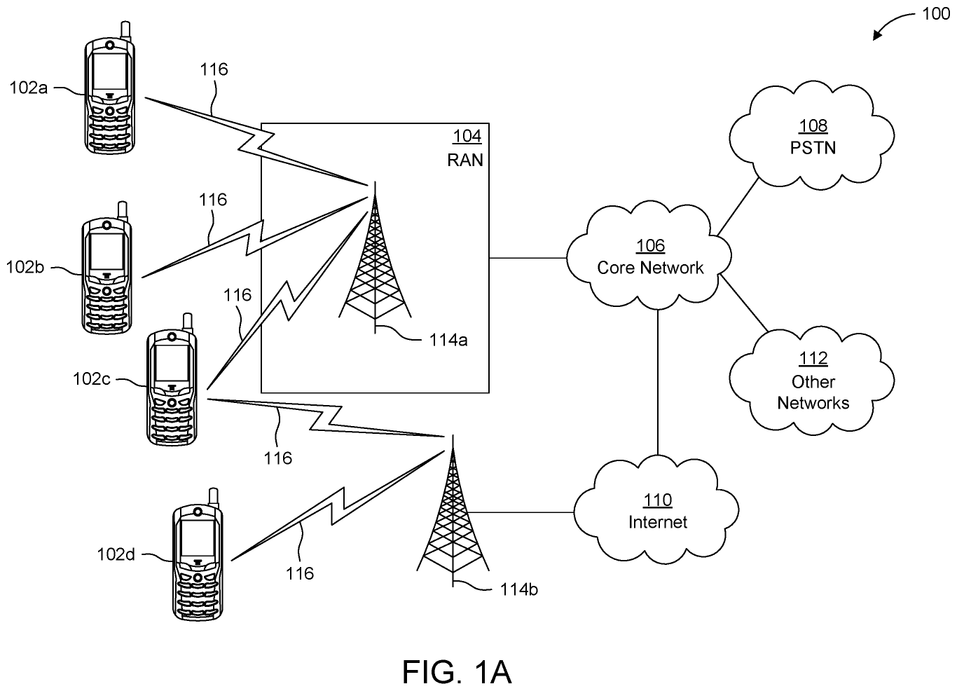

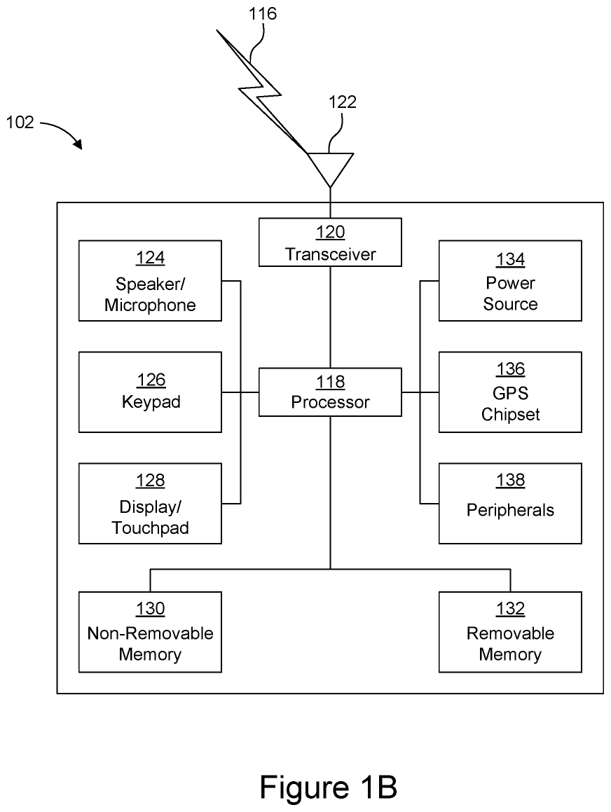

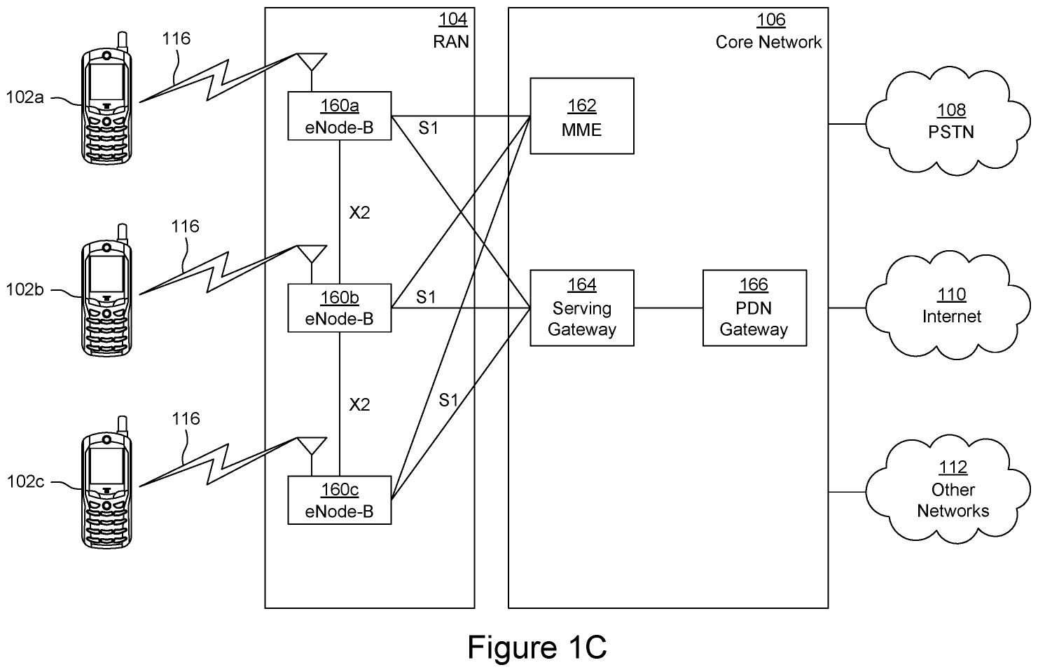

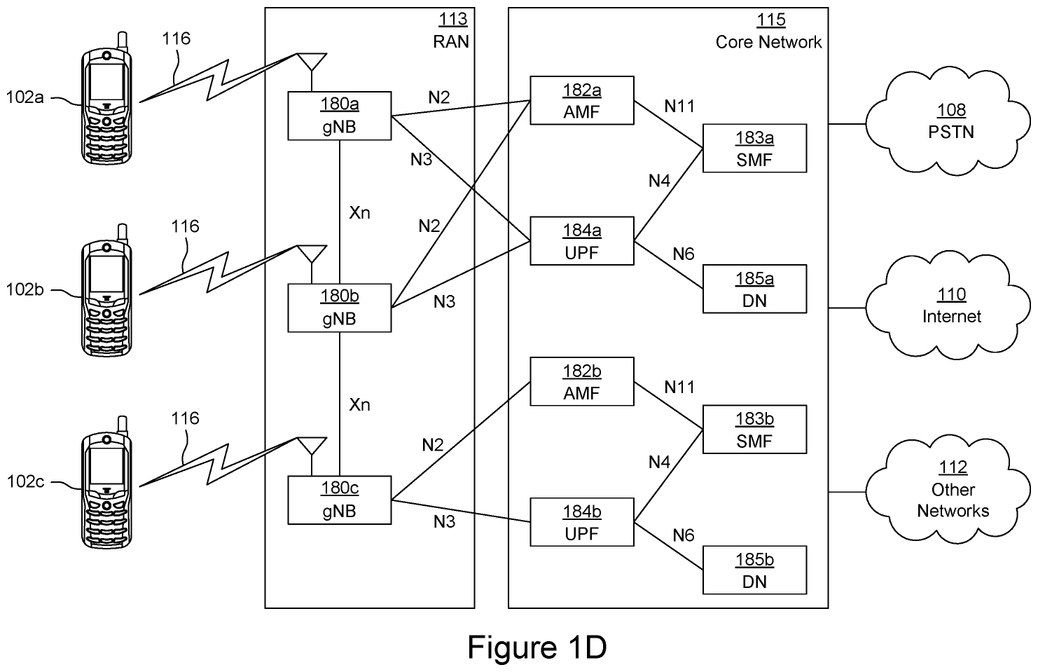

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliablelow latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain implementations, a reconfigurable intelligent surface (RIS), for example, those used for wireless communication systems may adapt to radio environment conditions. For example, a RIS may (e.g., electronically) control the propagation of impinging/ingress signals (e.g., beams, waveforms, transmissions, etc.) on a surface/element of the RIS (e.g., an ingress element), for example, for improving the received signal strength and/or spectral efficiency. A RIS may include one or more surfaces, which may be arranged in an array. For example, the surfaces/elements of the RIS may comprises energy-efficient elements (e.g., meta-surfaces, reflection-arrays, etc.), which may be passive and may not use a dedicated energy source.

RISs may be used to create a smart propagation environment (e.g., for future wireless communication systems). The elements of a RIS may, for example, be capable of intelligently altering the radio environment (e.g., by electronically controlling the propagation of the incident/impinging signals in a programmable manner to improve the system performance). The introduction of RISs to wireless communication system may allow scattering in an environment to be controllable.

As described herein, a RIS may include one or more (e.g., numerous) elements (e.g., sub-wavelength sized unit elements), which may be electronically controlled. In certain implementations, the RIS elements may include meta-surfaces/meta-elements and/or reflection-arrays. RIS elements may be closely-spaced, which may allow the RIS to operate as a scatterer (e.g., a smart scatterer), where each element may modify the properties of impinging signals (e.g., reflection, refraction and absorption). The RIS elements may be passive, active, and/or semi-active. For example, passive elements may passively reflect signals without amplification, while active elements may be capable of actively reflecting signals with amplification.

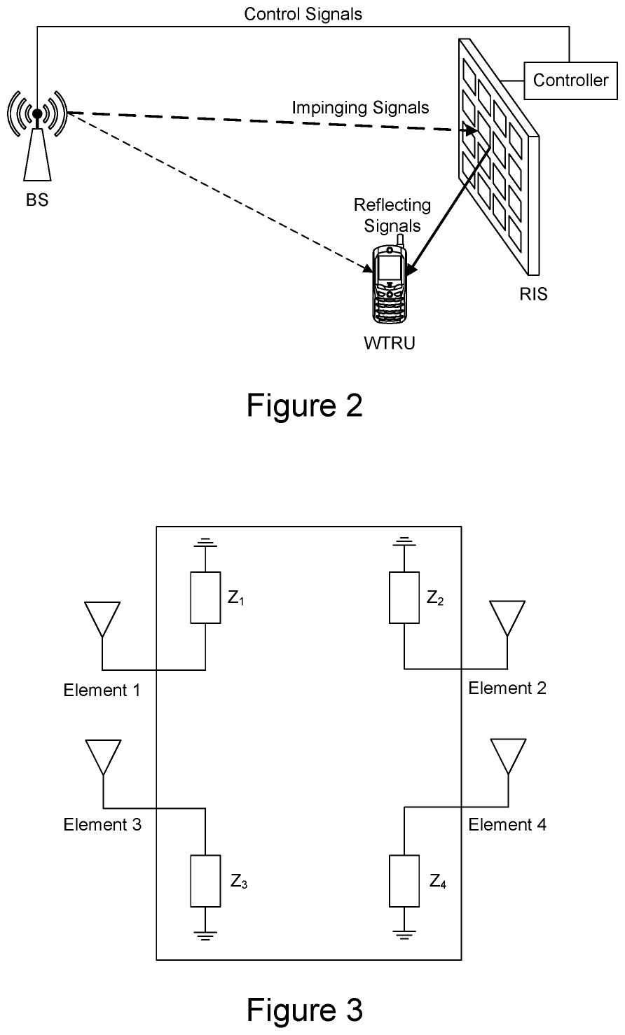

FIG. 2 illustrates an example wireless system that includes a RIS. As shown in FIG. 2, a RIS may be located between a network node, such as a transmitter (e.g., a BS, gNB, etc.), and a receiver (e.g., a WTRU). In such a case, for example, as shown in FIG. 2, one or more links may be established, including: a transmitter-RIS link, a RIS-receiver link, and a transmitter-receiver link. The transmitter-RIS link and/or the RIS-receiver link may aid/enhance the wireless system's performance, for example, when no direct link can be established between the transmitter and the receiver. For example, the RIS may propagate signals from the transmitter (e.g., via the transmitter-RIS link) towards the receiver (e.g., via the RIS-receiver link).

A controller associated with the RIS (e.g., a RIS controller) may be configured to propagate impinging signals from a transmitter towards the receiver. The controller may be configured to propagate the signals by applying a phase-shift. For example, the phase-shift may be applied using phase-shift matrix, which may be obtained from the network (e.g., via the transceiver). The controller may be configured to apply the phase-shift matrix by electronically controlling the elements of the RIS, e.g., via a respective load impedance connected to the elements (e.g., as illustrated in FIG. 3).

In certain scenarios, for example, as illustrated in FIG. 3, a RIS may be configured to reflect signals impinging on one element towards the receiver via the same element. In this scenario, a phase-shift may (e.g., only) be applied on the given element from which an impinging signal is reflected (e.g., a signal impinging on an element is reflected from that same element). In such a scenario, a load impedance may be directly connected to each individual element of the RIS, and each load impedance may be used to control incident/impinging signals on the respective RIS element. Referring to the example illustrated in FIG. 3, the load impedances that are connected to a single element may not be connected to other elements of the RIS array.

FIG. 3 illustrates an example 4×4 RIS array with single load impedances (e.g., a singularly connected RIS). Referring to FIG. 3, each load impedance Zᵢ may be connected to a single element. For example, load impedance Z₁ is connected to element 1; load impedance Z₂ is connected to element 2; load impedance Z₃ is connected to element 3; and load impedance Z₄ is connected to element 4. As shown in FIG. 3, the controller of the 4×4 RIS (e.g., the RIS controller) may adjust the impedance of the load connected to a given element, which may be used to control (e.g., reflect) a signal incident/impinging on that given element. For example, the impedance of a respective load connected to an element may be adjusted, which may be used to apply phase-shifts to signals that imping on that element.

Referring to the RIS illustrated in FIG. 3, an (N×N)-element phase-shift matrix Θ may be used to express the phase-shifts applied to the RIS elements and/or to express the load impedance connected to each respective element, where N refers to the size of the RIS. As illustrated in FIG. 3, interconnections may not exist between the individual elements of the RIS. If interconnections between the individual elements of the RIS do not exist, the phase-shift matrix (e.g., and/or control matrix) may be expressed as a diagonal matrix as shown in (1):

$$Θ = [ \begin{matrix}{e}^{j {θ}_{11}} & … & 0 \\ ⋮ & ⋱ & … \\ 0 & … & {e}^{j {θ}_{N N}}\end{matrix} ] \qquad ( 1 )$$

Referring to (1), Θ includes N phase-shift values (e.g., θ₁₁, . . . , θ_{NN}) with unity modulus, which may be due to the passive nature of the RIS elements. As described herein, passive elements may not apply amplification on incident/impinging signals. Referring again to a wireless communication system (e.g., like the one shown in FIG. 2) that includes a singularly connected RIS (e.g., as illustrated in FIG. 3), the system effective channel between the transmitter and receiver and through the RIS, may be provided using (2).

$$H = G Θ {H}_{r} \qquad ( 2 )$$

Referring (2), G denotes the channel between the transmitter and the RIS, Θ is the RIS control matrix, and Hᵣ is the channel between the RIS and the receiver. Based on (2), a RIS control matrix for a singularly connected RIS (e.g., as shown in FIG. 3) may be expressed in (3):

$$Θ = [ \begin{matrix}{e}^{j {θ}_{11}} & 0 & 0 & 0 \\ 0 & {e}^{j {θ}_{22}} & 0 & 0 \\ 0 & 0 & {e}^{j {θ}_{33}} & 0 \\ 0 & 0 & 0 & {e}^{j {θ}_{44}}\end{matrix} ] \qquad ( 3 )$$

Referring to (3), the control matrix may include a diagonal 4×4 matrix, where the 4 non-zero values that represent the configuration of the respective load impedances. The non-zero values of 0 may include phase-shift components (e.g., without any amplitude components because the elements of the RIS illustrated in FIG. 3 are passive and are not able to adjust the amplitude of impinging signals.

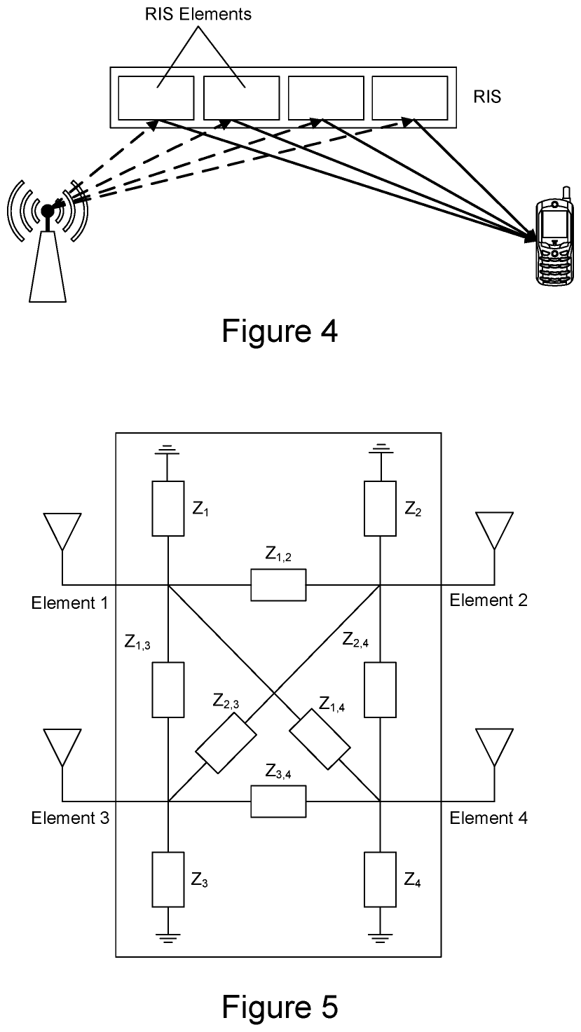

FIG. 4 illustrates an example associated with beamforming using a singularly connected RIS. As shown in FIG. 4, signals impinging on each respective element of the RIS (e.g., signals from the transmitter on the left of FIG. 4) may be reflected towards the WTRU on the right of FIG. 4 via that same element. Referring to the example illustrated in FIG. 4 (e.g., using a singularly connected RIS), the received signal power maximization problem (for optimizing capacity) may be provided by (4), (5), and (6), where N is the number of elements in the RIS:

$${max}_{G} {‖ G Θ {H}_{r} , ‖}^{2} \qquad ( 4 )$$

$$s . t . Θ = diag \{ {e}^{j {θ}_{11}} , {e}^{j {θ}_{22}} , … {e}^{j {θ}_{N N}} \} \qquad ( 5 )$$

$${θ}_{k k} ∈ [ 0 , 2 π ) , k = 1 , 2 , … , N \qquad ( 6 )$$

As illustrated, although a control matrix Θ for a singularly connected RIS may reflect signals impinging on a given element towards a WTRU, an amplitude mismatch between the incident/impinging signals and the reflected signal may occur. For example, a singularly connected RIS may not be able to optimally direct impinging signals towards the WTRU, e.g., due to amplitude mismatch between the incident/impinging signal and the reflected signal. The amplitude mismatch caused by a singularly connected RIS, may not achieve an optimal channel gain (e.g., may result in a sub-optimal channel gain).

FIG. 5 illustrates another example associated with a 4×4 element RIS. Referring to the example illustrates in FIG. 5, each of the elements of the RIS may be interconnected, for example, via a load impedance network. The example illustrated in FIG. 5 may be referred to herein as a fully connected RIS. For example, a fully connected RIS may be capable of increasing the signal power of impinging signals (e.g., as compared to singularly connected RIS). If, for example, a fully connected RIS (e.g., a RIS capable of increasing the signal power of impinging signals, as shown in FIG. 5) is implemented in a wireless communication system, such as the system illustrated in FIG. 2, the control matric associated with the fully connected RIS may include as many as (N×N) non-zero entries, which may cause an increased signaling overhead between the network (e.g., the transmitter) and the RIS.

Certain research is being directed towards singularly connected RISs technology. For example, certain RIS related research is directed to optimization of an on-diagonal control matrix associated with a singularly connected RIS, without improving the structure/design of the RIS array. A singularly connected RIS, however, which includes a single load impedance connection (e.g., such that a signal impinging on a given element is only reflected of that same element after phase shift adjustment), may not allow each of the respective elements of the RIS to cooperate with each other. Given its inability to allow respective elements of the RIS to cooperate with each other, singularly connected RISs may also not realize the full potential each of the elements of the RIS and may not enhance system performance.

Certain other research is being directed towards fully-connected RISs, which may result in certain performance enhancements. But the performance enhancements of certain fully connected RISs (e.g., such as the RIS illustrated in FIG. 5) may also result in higher computational complexity for optimizing the associated phase shift matrix. For example, in the case of an N-element fully connected RIS, a total of (N×N) entries of the phase shift matrix may be optimized, which may increase cost and complexity (e.g., as compared to a singularly connected RIS). Further, the control matrix for certain fully-connected RISs may be symmetrical (e.g., may need to be symmetrical) since, for example, the connection between element 1 and element 2 may be the same as the connection between element 1 and element 1 (e.g., as shown in FIG. 5). Such constraints may restrict the flexibility of certain fully connected RIS designs. Such constraints may also restrict solutions for signal optimization (e.g., beamforming), which may result in sub-optimal solutions for the associated control matrix.

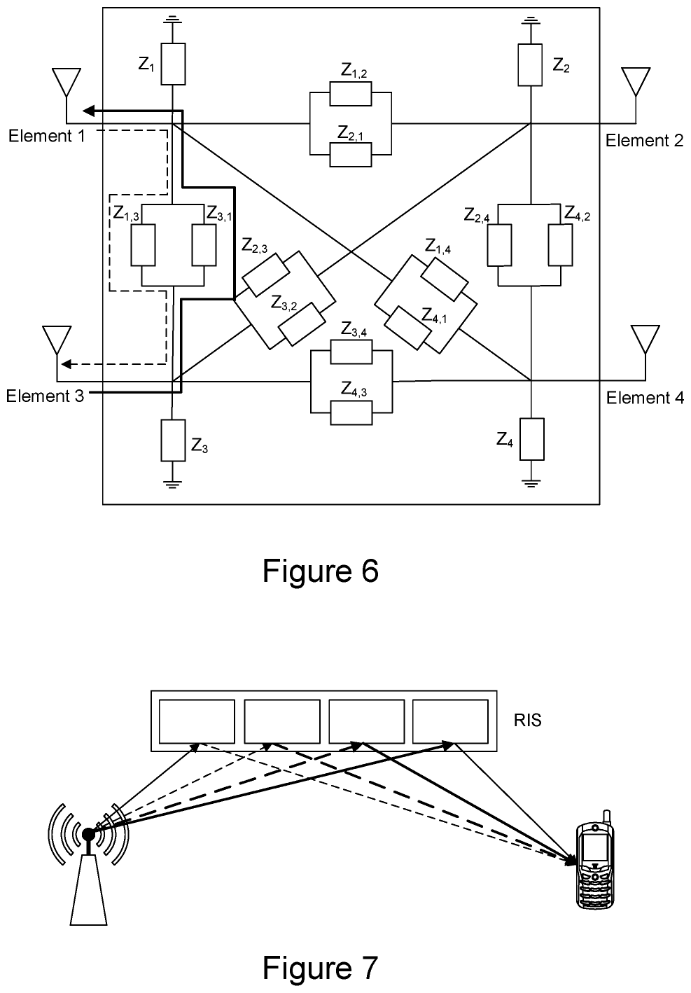

Described herein are certain techniques to enhance the structure and design of a RIS, including, for example, implementation of an off-diagonal beamforming scheme and a RIS based that includes a multi-directional and fully connected load impedance network (e.g., as illustrated in FIG. 6). Off-diagonal beamforming techniques may be employed in certain RIS-aided wireless system (e.g., a wireless system that includes a multi-directional and fully connected RIS). Such RIS-aided wireless systems may include a transmitter (e.g., a network node, such as a BS), a receiver (e.g., a WTRU), and a RIS (e.g., a multi-directional and fully connected RIS). For example, the RIS may be configured (e.g., by/via the transmitter) to beamform incident/impinging signals (e.g., signal received from the RIS that impinge on a surface of the RIS) towards the receiver. However, the present disclosure is not limited thereto. For example, the beamforming techniques discussed herein may also, or alternatively, be applied to received signal beamforming.

As described herein, a multi-directional and fully connected RIS may include a multi-directional fully-connected load impedance network. For example, the fully-connected load impedance network may be configured to route signals impinging/ingress (e.g., signals commencing at the transmitter) on an ingress element to an egress element. The egress element may be determined (e.g., determined by the RIS controller or configured by the network) such that certain performance objectives (e.g., expressed in terms of desired channel characteristics between the RIS and the receiver) are achieved. The egress element may or may not be the same as the ingress element (e.g., the element on which the signal impinges). In certain implementations, the beamforming matrix that is used to route impinging signals from the ingress element to the egress element may be an off-diagonal matrix (e.g., an off-diagonal beamforming matrix). According to embodiments, an ingress element may be the same as an egress element, for example, if the ingress and egress beams have an optimal match.

Such an off-diagonal beamforming technique is not limited to a RIS array design having a signal impinge on a first element and be reflected from a different/second element. That is, according to embodiments, an off-diagonal beamforming scheme may be applied to a variety of RIS array designs including any number of elements (e.g., antennas, arrays, etc.), and any number of ingress signals, for example, at any number of ingress elements, that are reflected via any number of egress/reflected signals, for example, at any number of egress elements, that may be or may not be the same as the ingress elements. According to embodiments, reflection of an (e.g., RF) signal may include any of refraction, diffraction, absorption, and any other similar and/or suitable propagation of the signal.

A RIS that includes a multi-directional and fully connected load impedance network may be provided (e.g., a multi-direction and fully connected RIS). The RIS may include a plurality of elements, and each of the plurality of elements configured to receive and/or transmit signals. For example, each element of the RIS may be connected to each of the other elements of the RIS via a load impedance network that is configured to provides multi-directional connections between each of the plurality of elements. The RIS may include a controller (e.g., a RIS controller). The RIS controller may receive a first feedback (e.g., from the network) that comprises channel quality information associated with a wireless channel between the RIS and at least one other device (e.g., a transmitter, such as a gNB, or a receiver, such as a WTRU). The RIS controller may determine routing information for the plurality of elements of the RIS based on the first feedback. For example, the routing information may comprise a mapping of ingress signals from each of the plurality of elements to egress signals from each of the other elements of the plurality of elements. A first signal may be received via a first element of the plurality of elements (e.g., an ingress element). The RIS controller may route the first signal to at least a second element of the plurality of elements (e.g., an egress element) based on the determined routing information. For example, the signal may be phase-shifted while being routed from the ingress element to the egress element. The RIS controller may transmit the phase shifted first signal via the second element.

The RIS controller may receive a second feedback that comprises updated channel quality information associated with the wireless channel between the RIS and the at least one other device. The RIS controller may determine updated routing information based on the second feedback. A second signal may be received via the first element. The RIS controller may route the second signal to at least a third element of the plurality of elements based on the determined routing information. For example, the signal may be phase-shifted while being routed from the first element to the third element. The RIS controller may transmit the phase shifted second signal via the third element.

As described herein, the RIS controller may determine routing information based on feedback (e.g., received from a transmitter or a receiver). For example, the RIS controller may determine channel coefficients (e.g., channel coefficients that comprise amplitude components) associated with the wireless channel between the RIS and the device that transmitted the feedback. The RIS controller may sort the determined channel coefficients associated with the wireless channel between the RIS and the device that transmitted the feedback. The determined routing information is further based on the sorted channel coefficients associated with the wireless channel between the RIS and the device that transmitted the feedback.

A WTRU, may be configured to communicate with a RIS/RIS controller. The WTRU may determine channel quality information for a wireless channel associated with the RIS. The WTRU may determine a first feedback information based on the channel quality information. For example, the first feedback may comprise signal routing information and phase shift information. In certain implementations, the signal routing information may comprise an indication that a signal received via a first element of the RIS should be routed to a second element of the RIS for transmission. Similarly, the phase shift information may indicate a phase shift that should be applied to the signal received via the first element of the RIS that is routed to the second element of the RIS for transmission. The WTRU may transmit the first feedback to the RIS (e.g., via the RIS controller). The WTRU may determine second feedback information that comprises updated phase shift information. For example, the updated phase shift information may indicate an updated phase shift that should be applied in accordance with the routing information comprised in the first feedback. The WTRU may transmit the second feedback to the RIS controller.

In certain implementations, the WTRU may periodically determine updated phase shift information based on signals received from the RIS, and the updated phase shift information may indicate phase shifts that should be applied to the signals received via the first element. The WTRU may periodically transmit the updated phase shift information to the RIS. Also, or alternatively, the WTRU may periodically determine updated signal routing information based on signals received from the RIS. For example, the updated signal routing information may comprise an indication that signals received via the first element of the RIS should be routed to a third element of the RIS for transmission. The WTRU may periodically transmit the updated signal routing information to the RIS. The updated phase shift information may periodically transmitted to the RIS more frequently than the updated routing information to the RIS is periodically transmitted to the RIS.

As described herein, a multi-directional and fully-connected RIS may include a multi-directional and fully-connected load impedance network. FIG. 6, for example, illustrates an example multi directional and fully-connected RIS that includes a multi-directional and fully-connected load impedance network. As illustrated in FIG. 6, a multi-directional and fully-connected RIS that includes a multi-directional and fully connected load impedance network may provide routing of impinging signals from an ingress element to an egress element. Such a RIS may also, or alternatively, be configured to apply a control matric to the signal. For example, a control matric may be applied at the RIS, wherein the control matric is configured to perform phase-shifts and/or signal routing. Although the techniques described herein relate to phase-shifts and/or signal routing, other techniques may also be employed, including, for example, signal amplification, modulation, etc. According to embodiments, phase-shifts may be characterized in the non-zero elements of the off-diagonal matrix, while the routing is indicated by the position of the non-zero elements in the same matrix. Such a RIS may provide for enhanced signal reception at the receiver.

The RIS illustrated in FIG. 6 may provide one or more of the following: (1) routing of an impinging signal within the RIS (e.g., via the multi-directional and fully connected load impedance network) from an (e.g., ingress, one, first, etc.) element to another (e.g., egress, second, etc.) element; and (2) applying a control matric. According to embodiments, such a RIS array structure design may improve the performance of a RIS, and may enhance signal reception, for example, at a receiver side.

As shown in FIG. 6, a RIS may comprise one or more elements (e.g., elements, 1, 2, 3, 4), where each of the one or more elements are organized/arranged into an array. Each of the one or more elements of the RIS may further be connected to each other (e.g., described herein as a fully-connected RIS). The connections between each of the one or more elements may also be multi-directional (e.g., two respective elements may be connected to each over via multiple paths and/or in multiple directions). For example, each of the elements within the RIS may be connected via a network of load impedances (e.g., passive load impedances). According to embodiments, such an RIS array may have interconnected array (e.g., antenna) elements, for example such that any/all elements of the RIS array are connected to any/all other elements of the RIS array. For example, referring to FIG. 6, an RIS array may have a connection between two elements, the connection having separate paths for two (e.g., respective) directions.

Referring again to FIG. 6, a (4×4)-element RIS array may include a multi-directional network of load impedances (e.g., passive load impedances), where the impedance Z_{i,j} may denotes the load impedance between an ingress element i and an egress element j, and where direction of the connection is from element i to element j. For example, an impedance Z_{j,i} denotes the load impedance between the ingress element j and the egress element i, in the direction of element j to element i. Similarly, an impedance Z_{i,j} denotes the load impedance between the ingress element i and the egress element j, in the direction of element i to element j (e.g., impedances Z_{i,j}≠Z_{j,i}). Referring again to FIG. 6, element 1 and element 3 may be connected over Z_{1,3}, for example, in the direction of/from the ingress element 1 to egress element 3. Similarly, element 3 and element 1 may be connected over Z_{3,1}, wherein the direction of the connection is of/from ingress element 3 to egress element 1. As shown, the RIS illustrated in FIG. 6 differs from the RIS illustrated in FIG. 5, where two respective elements are connected in a single direction.

Although FIG. 6 illustrates an example (4×4)-element RIS array, a multi-directional and fully connected load impedance network may be applied to a RIS with a larger array (e.g., a larger number of elements, connections, routes, etc.). For example, in a larger fully-connected RIS array, one or more of the elements within the RIS may be split into groups, and off-diagonal beamforming may be applied to (e.g., each, any, all, some, respective, etc.) groups.

As described herein, a controller associated with a RIS (e.g., a RIS controller) may control the multi-directional and full connected load impedance network within the RIS. As described herein, a RIS may be configured such that signals impinging on an (e.g., one, ingress, etc.) element are routed to another (e.g., second, egress) element, referred to herein as routing information. Such a RIS controller, for example, may, based on the routing information, route a signal impinging on/at an ingress element i towards an egress element j via a load impedance Z_{i,j}. Also, or alternatively, the RIS controller may set the impedance of the route associated with the other direction (e.g., the route from element j towards element i) to zero, e.g., Z_{j,i}=0. Similarly, in order to route a signal from ingress element 1 to egress element 4 (e.g., element 1 element 4), a load impedance in the direction of element 1 to element 4, e.g., load impedance Z_{1,4}, may be adjusted according to a corresponding phase-shifts, as described herein. A load impedance in the direction of element 4 to element 1 (e.g., element 4→element 1), via load impedance Z_{4,1} may be turned off (e.g., Z_{4,1}=0). Adjusting the load impedance Z_{1,4}, may be adjusted according to a corresponding phase-shift

In certain scenarios, the RIS controller may determine routing information that routes a signal impinging on ingress element 2 to egress element 2. If, for example, the RIS control determines to route a signal impinging on ingress element 2 to egress element 2, the load impedances connected to element 2 (e.g., all load impedances connected to element 2) may be set to zero (e.g., Z_{2,j}=0), and a load impedance for element 2 may be set to Z₂=e^{jθ}^{₂₂}. The corresponding control matrix Θ (e.g., routing information) may be expressed as an off-diagonal control matrix, as shown in (7):

$$Θ = [ \begin{matrix}0 & 0 & 0 & {e}^{j {θ}_{14}} \\ {e}^{j {θ}_{21}} & 0 & 0 & 0 \\ 0 & {e}^{j {θ}_{32}} & 0 & 0 \\ 0 & 0 & {e}^{j {θ}_{43}} & 0\end{matrix} ] \qquad ( 7 )$$

As shown, the routing information may include the off-diagonal control matrix shown in (7), which may include N non-zero values. For example, such a control matrix (e.g., which may be interchangeably referred to as a phase-shift matrix) may be referred to as an off-diagonal beamforming matrix and/or may be used to route signals via off-diagonal beamforming.

An off-diagonal beamforming matrix Θ (e.g., such as the one shown in (7) may also, or alternatively, be used as a routing matrix (e.g., routing information). For example, the position of each of the non-zero values in the off-diagonal control matrix may refer to a routing path in a RIS array. For example, a non-zero element in the i-th row and the j-th column of Θ may refer to the routing on the signal impinging on ingress element i to reflect from egress element j.

FIG. 7 illustrates an example wireless system that includes a fully-connected and multi-directional RIS that performs off-diagonal beamforming. As shown in FIG. 7, a fully-connected multi-directional RIS may route (e.g., perform routing of/for) four signals (as illustrated in FIG. 7, each signal is shown with a different line pattern). Each of the 4 signals may impinge on an element of a 4-element RIS. If, for example, the off-diagonal control matrix shown in (7) is used, one or more of the following may apply: signal (1) may impinge on ingress element 1 and the RIS controller may route the signal to egress element 4; signal (2) may impinge on ingress element 2 and the RIS controller may route the signal to egress element 1; signal (3) may impinge on ingress element 3 and the RIS controller may route the signal to egress element 2; and/or signal (4) may impinge on ingress element 4 and the RIS controller may route the signal to egress element 3. As described, the routing information may comprise the off-diagonal control matrix (7), and the non-zero values in the off-diagonal control matrix (7) may include the phase-shift components. In certain implementations, however, an off-diagonal control matrix may also include signal amplification components. For example, the RIS controller may route signals from a given ingress element to an egress element that exhibits an amplitude match.

As described herein, a RIS may include a multi-directional and fully connected load impedance network. For example, the RIS may be structured and/or designed such that the RIS array includes a multi-directional and fully connected load impedance network. One or more antenna designs relating to a RIS array that include a multi-directional and fully connected load impedance network are provided herein. Referring to FIGS. 6 and 7, for example, directional transmission of signals between the different elements of a RIS may be performed according to a function ƒ( ). Depending on the implementation of the function ƒ( ), RF couplers and/or RF isolators may be employed. For example, the RF couplers and/or RF isolators may be used to passively route signals between elements of the RIS, while also employing/applying phase shifts. Passive phase shifters may also, or alternatively, be employed with the RF couplers and/or RF isolators, for example, to improve the accuracy of the applied phase shifts. It should be understood that the techniques described herein can be implemented in multiple scenarios. Further, although certain techniques described herein employ passive elements, active elements may also, or alternatively, be used.

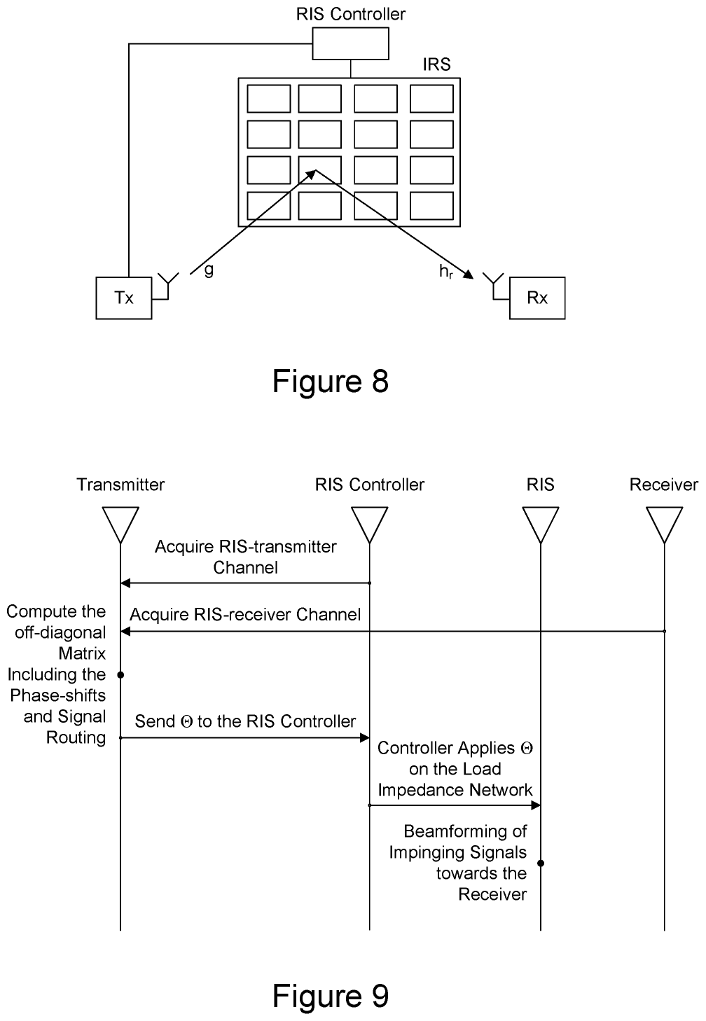

Off-diagonal beamforming techniques may be employed in a RIS-aided single-input-single-output (SISO) system (e.g., wireless communication system). FIG. 8, for example, illustrates an example RIS-aided single-user system, according to embodiments. One or more of the following may apply. As shown in FIG. 8, a RIS-aided SISO system may include a transmitted (e.g., a single antenna transmitter), an N element RIS, and a receiver (e.g., a single antenna receiver). In such a case, an off-diagonal beamforming scheme (e.g., technique) may be used to apply phase-shifts (e.g., optimal phase shifts) and network routing for a single user.

Referring to FIG. 8, one or more of the following may apply: the transmitter may be aware of (e.g., have full knowledge of) the channel information for channel between the transmitter and the RIS array, and the channel between the RIS and the receiver; and a channel (e.g., the direct channel) between the transmitter and the receiver(s) may be blocked; and/or the RIS may create an additional middling communication link between the transmitter and the receiver(s) (e.g., as shown in FIG. 2).

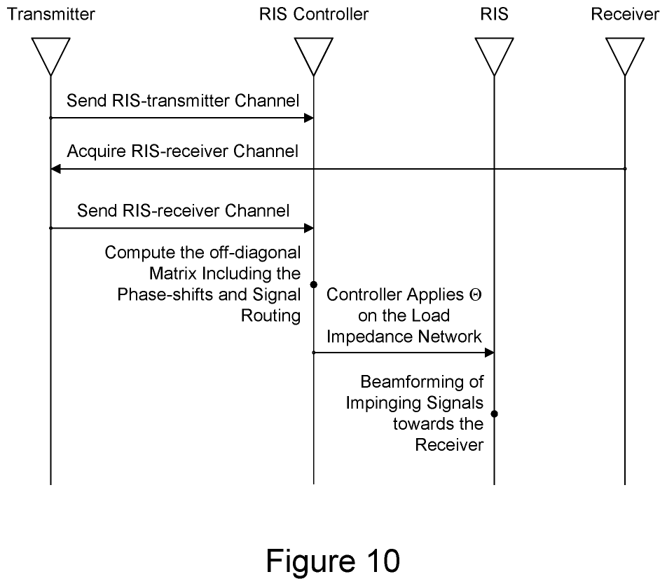

As described herein, routing information that includes an off-diagonal control matrix may be used in a RIS-aided wireless communication system. The routing information/off-diagonal matrix may be computed/determined at the transmitter and/or by the RIS controller. FIG. 9 illustrates and example message flow for a transmitter centric off-diagonal beamforming scheme, according to embodiments. FIG. 10 is a diagram that illustrates an example message flow for a RIS controller centric off-diagonal beamforming scheme.

Referring to FIG. 9 (e.g., where the routing information/off-diagonal control matrix is computed at the transmitter), the transmitter may generate certain control information, and transmit the control information to the RIS controller. For example, one or more of the following may apply in the generation of the control information: the transmitter to compute (e.g., generate, determine, etc.) the off-diagonal control matrix Θ based on channel information (e.g., channel information associated with the channel between the transmitter and the RIS, the RIS and the receiver, and/or the transmitter and the receiver); the transmitter may control the RIS array via a connection (e.g., a direct connections) with the RIS controller; and/or the transmitter may signal (e.g., transmit) the off-diagonal control matrix to the RIS controller.

According to embodiments, a connection between the transmitter and the RIS controller may be any of: (1) a base station to WTRU connection, (2) a WTRU to WTRU connection, or (3) another connection/interface (e.g. a X2 interface). Further, according to embodiments, the RIS controller may be included (e.g., located, disposed, hosted, instantiated, etc.) in the same base station and/or the same WTRU that includes the transmitter. Furthermore, according to embodiments, the RIS controller may be included in a different base station, a different node (e.g., an edge server), or a different WTRU, than that with includes the transmitter. That is, the RIS controller may be an entity included in any suitable device allowing for the network and/or a WTRU to control an RIS, which is a passive surface.

As described herein, the routing information/off-diagonal matrix may be computed by the RIS controller (e.g., RIS controller centric off-diagonal beamforming scheme). FIG. 10 illustrates an example message flow associated with a RIS controller centric off-diagonal beamforming scheme. Referring to FIG. 10, the RIS controller may generate the routing information. One or more of the following may apply with respect to generation of the routing information by the RIS controller: the transmitter may transmit channel information associated with the transmitter-RIS channel to the RIS controller; the transmitter may transmit channel information associated with the RIS-receiver channel to the RIS controller; and/or the RIS controller may compute (e.g., generate, determine, etc.) the routing information that includes an off-diagonal control matrix Θ, for example, based on the channel information received from the transmitter.

The RIS controller may use the generated routing information/off-diagonal control matrix to control the RIS to perform one or more of the following. The RIS controller may use the generated off-diagonal control matrix to control the RIS to route a signal impinging on an ingress element towards the egress element having a certain (e.g., the best) reflecting channel (e.g., with the receiver). The RIS controller may use the generated off-diagonal control matrix to control the RIS to apply phase-shift adjustments on a (e.g., each) RIS element.

The channel vector between the transmitter and the RIS (e.g., a transmitter-RIS channel vector) may be represented as g=[g₁ . . . g_{N}]. The channel vector between the RIS and the receiver (e.g., a receiver-RIS channel vector) may be represented as hᵣ=[h_{r,1} . . . h_{r,N}]. gₙ and h_{r,n} may denote the n-th impinging signal and the n-th reflecting channel coefficient at the n-th RIS element, respectively. For a case of such channel vectors, a direct link between the transmitter and the receiver may be blocked.

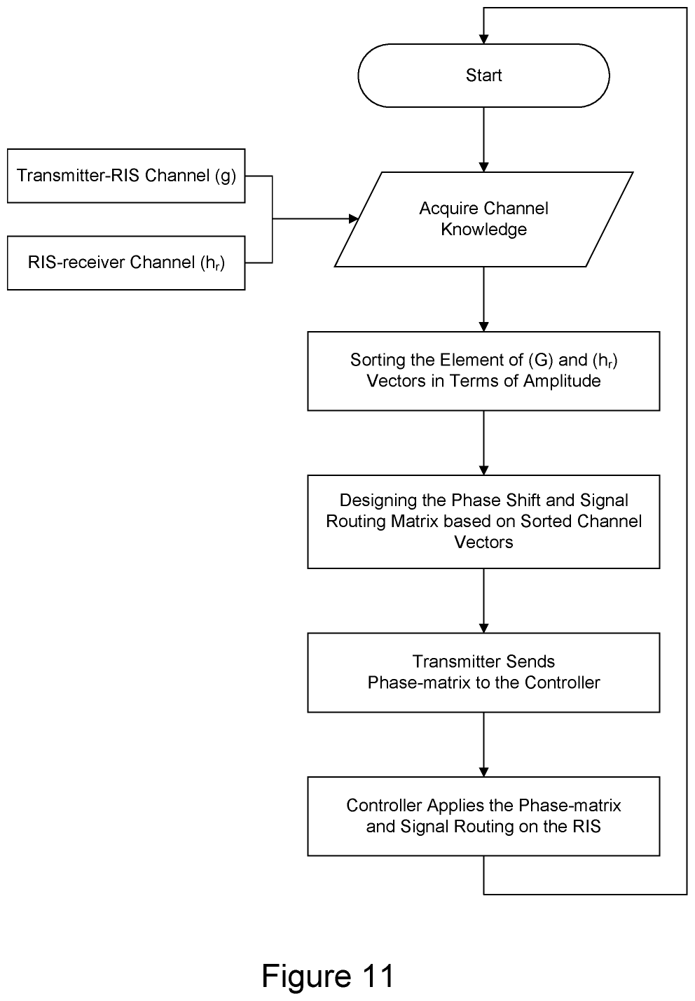

FIG. 11 illustrates an example associated with determining routing information for a RIS that employs off-diagonal beamforming. As described herein, routing information/off-diagonal control matrix may be produced (e.g., generated, computed, etc.) at a transmitter (e.g., a BS) and/or a RIS controller. One or more of the following may apply. A transmitter-RIS channel vector g (e.g., for impinging/ingress channels) may be acquired (e.g., by the transmitter and/or the RIS controller). A RIS-receiver channel vector hᵣ (e.g., for regress channels) may be acquired (e.g., by the transmitter and/or the RIS controller). Respective amplitude components for each of the acquired channels may be calculated (e.g., by the transmitter and/or the RIS controller), for example, as |g₁|², . . . , |g_{N}|² and |h_{r,1}|¹², . . . , |h_{r,N}|². The transmitter-RIS channel vector and/or the RIS-receiver channel vector g and hᵣ may be sorted, e.g., as g̅ and h̅ᵣ, respectively. Based on the sorted channel vectors g̅ and h̅ᵣ, the phase shifts and/or control matrix (e.g., \tilde{Θ}) may be generated/determined (e.g., by the transmitter and/or the RIS controller). If, for example, the routing information (e.g., phase shifts and/or control matrix \tilde{Θ}) are generated/determined by the transmitter, the phase shifts and/or control matrix \tilde{Θ} may be signaled from the transmitter (e.g., the BS) to the RIS controller. The RIS controller may then route impinging signal from an ingress element to an egress element based on the routing information (e.g., phase shifts and/or control matrix), for example, using the load impedance network of/in the RIS.

As described herein, routing information that includes an off-diagonal control matrix may be generated at a transmitter (e.g., a BS) and/or a RIS controller. For example, the off-diagonal control matrix may be generated using a RIS phase-shifting, such as in (8):

$${θ}_{i j} = - ( {∠ [ {\overline{h}}_{r}^{h} ]}_{i} + {∠ [ \overline{g} ]}_{j} ) \qquad ( 8 )$$

Referring to (8), θ_{i,j} may refer to the phase-shift applied at the i-th row and j-th column of \tilde{Θ}. The position of θ_{i,j} at the i-th row and j-th column of \tilde{Θ} may denote the routing of the signal impinging on ingress element i to egress element j.

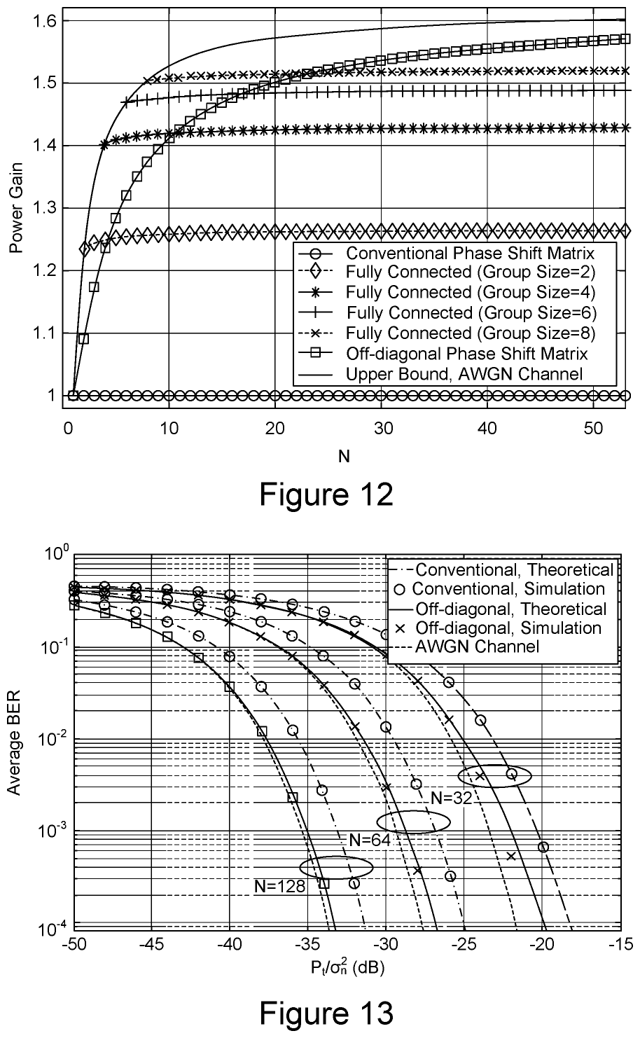

FIG. 12 illustrates an example comparison between the number of elements N in RIS and the upper bound in an additive white Gaussian noise (AWGN) channel. Referring to FIG. 12, a comparison of the respective power gains of different RIS array structures/designs, including: a single-connected RIS (e.g., as illustrated in FIG. 3); fully-connected RIS (e.g., as illustrated in FIG. 5); and a fully-connected multi-directional RIS that implements an off-diagonal beamforming scheme (e.g., as illustrated in FIG. 6). Also shown in FIG. 12 is the upper bound of system that does not include a RIS, e.g., via the power gain of an AWGN channel. As shown, the power gain of a fully-connected multi-directional RIS that implements off-diagonal beamforming approaches the upper bound of an AWGN channel, as the number of elements N increases.

FIG. 13 illustrates a comparison of the bit error rate (BER) performance comparison of different RIS array structures/designs, including: a single-connected RIS (e.g., as illustrated in FIG. 3); and a fully-connected multi-directional RIS that implements an off-diagonal beamforming scheme (e.g., as illustrated in FIG. 6). Also shown in FIG. 13 (e.g., for benchmarking) is the BER of system that does not include a RIS, e.g., via the power gain of an AWGN channel. As shown, the BER of a fully-connected multi-directional RIS that implements off-diagonal beamforming may be lower than other RIS designs (e.g., a single-connected RIS). The BER of a fully-connected multi-directional RIS that implements off-diagonal beamforming may approaches the AWGN system performance as the number of RIS elements N increases.

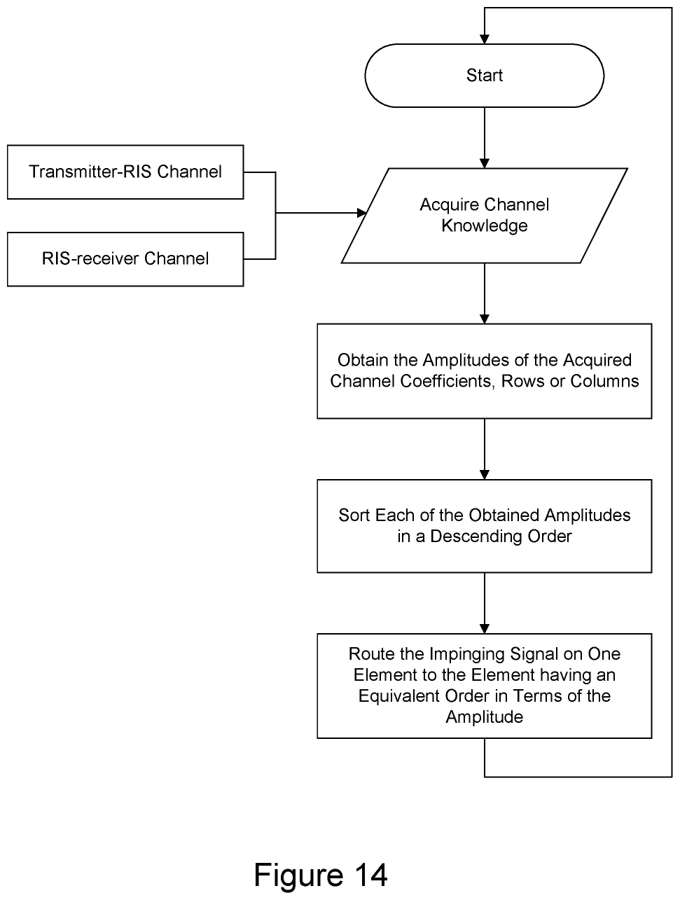

Routing information that routes signals from an ingress element of a RIS to an egress element of the RIS may be determined using channel elements sorting techniques. FIG. 14, for example, illustrates an example associated with determining routing information based on a sorting of channel amplitudes. A channel element(s) sorting procedure, which may also, or alternatively, be referred to as a sorting procedure, may be applied prior to obtaining and/or optimizing the control matric, for example, to determine the route of impinging signals within the RIS. As described herein, sorting of the ingress channel and/or the sorting of egress channel may allow a transmitter to match each pair of elements (e.g., each pair of ingress/egress elements) to obtain a desired (e.g., optimal) beamforming gain. For example, the transmitter may match a pair of elements (e.g., a pair of ingress/egress elements) according to their channel amplitudes, for example, by matching the maximal ratio combining (MRC) criterion. As shown in FIG. 14, after channel sorting, phase-shifts and/or a control matrix may be determined.

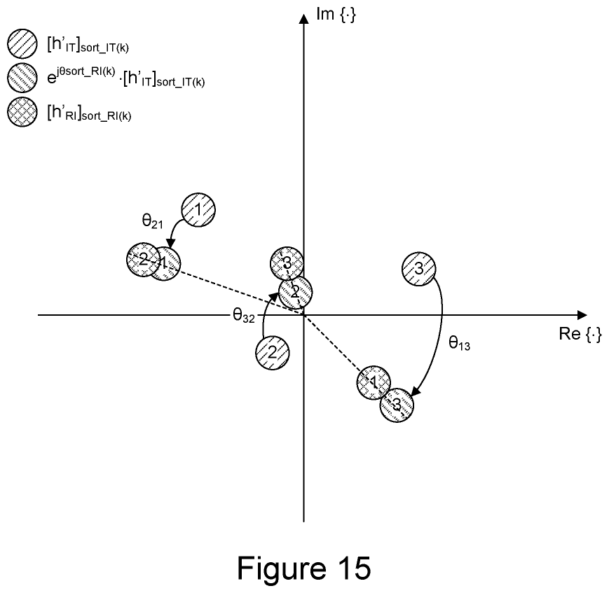

FIG. 15 illustrates an example associated with the ingress and egress channel elements of a fully-connected and multi-directional RIS. As show, FIG. 15 refers to a RIS-aided system, wherein the RIS includes N=3 elements. Referring to FIG. 15, the ingress and egress channel elements are shown in respective patterns having a right-to-left slash and a cross-hatch, and the off-diagonal beamformed signal is shown having a left-to-right slash pattern. According to embodiments, an off-diagonal beamforming procedure may be for reflecting signals impinging via impinging channels over/via certain (e.g., the best) reflecting channels. After sorting the ingress elements according to their respective amplitude, the ingress elements may be ordered as {2, 3, 1}, as shown in (9):

$$\frac{{g}_{2}}{‖ {g}_{2} ‖} < \frac{{g}_{3}}{‖ {g}_{3} ‖} < \frac{{g}_{1}}{‖ {g}_{1} ‖} ; \qquad ( 9 )$$

Similarly, the egress channels may be sorted as {3, 1, 2}, as shown in (10):

$$\frac{{h}_{r , 3}}{‖ {h}_{r , 3} ‖} < \frac{{h}_{r , 1}}{‖ {h}_{r , 1} ‖} < \frac{{h}_{r , 2}}{‖ {h}_{r , 2} ‖} \qquad ( 10 )$$

Referring to (9) and (10), and FIG. 15, impinging signals may be routed as follows: signals impinging on element 2 (e.g., the ingress element) may be routed to element 3 (e.g., the egress element); signals impinging on element 3 (e.g., the ingress element) may be routed to element 1 (e.g., the egress element); and/or signals impinging on element 1 (e.g., the ingress element) may be routed to element 2 (e.g., the egress element). The corresponding an off-diagonal (e.g., routing/control) matrix may be as expressed, for example, as shown in (11):

$$\tilde{Θ} = [ \begin{matrix}0 & 0 & {e}^{j {θ}_{13}} \\ {e}^{j {θ}_{21}} & 0 & 0 \\ 0 & {e}^{j {θ}_{32}} & 0\end{matrix} ] \qquad ( 11 )$$

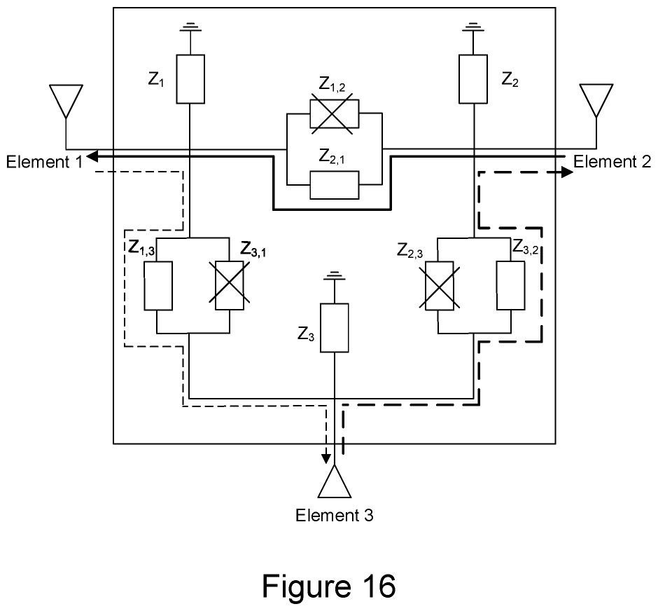

FIG. 16 illustrates an example fully-connected and multi-directional RIS that includes 3 elements (e.g., elements 1, 2, 3). Referring to FIG. 16, the route of signals based on determined routing information that includes an off-diagonal control matrix is shown by different line types/patterns/sizes/etc. As described herein, a sorting procedure may be applied to one or more of the following: elements in channel vectors, elements in channel matrices, and/or vectors (e.g., rows and columns) in channel matrices. Also, or alternatively, the channel vectors and/or matrices may be processed, for example, using transmitter precoding and/or receiver combining methods.

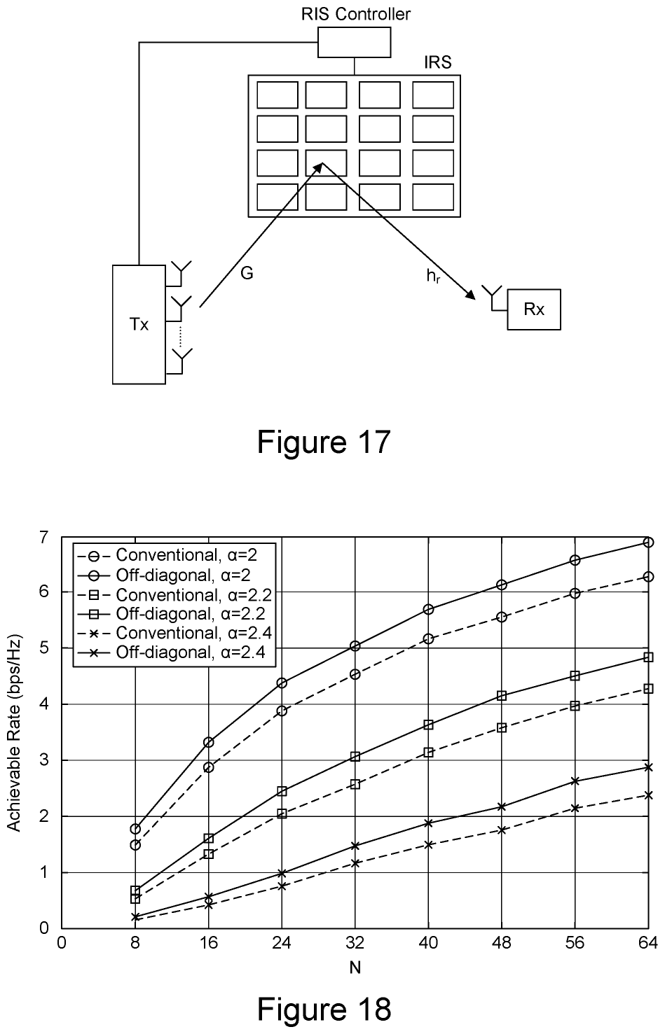

In certain scenarios, a RIS (e.g., a fully-connected multi-directional RIS) may be implemented in a multi-input single-output (MISO) system (e.g., referred to herein as a RIS-aided MISO system). FIG. 17 illustrates an example associated with a RIS-aided MISO system. One or more of the following may apply. As shown in FIG. 17, off-diagonal beamforming may be used (e.g., applied, extended, performed, etc.) in a RIS-aided multi-MISO system. For example, a RIS-aided MISO system may include a transmitter with multiple antennas, an N element RIS (e.g., an N element fully-connected and multi-directional RIS), and a single antenna receiver (e.g., a WTRU). Referring to FIG. 17, the transmitter-RIS channel matrix may be represented as G, and the receiver-RIS channel vector may be represented as hᵣ. In certain implementations, the channel between the transmitter and the RIS may be expressed as a matrix. If the channel between the transmitter and the RIS is expressed as a matrix, a precoding layer (e.g., an additional precoding layer) may be used at the transmitter, for example, to achieve optimal RIS performance. Referring to the example illustrated in FIG. 17, the transmitter and RIS controller may use channel information associated with the transmitter-RIS channel and channel information associated with the RIS-receiver channel, for example, to jointly compute/determine routing information. For example, the routing information may include a precoding vector w and the corresponding off-diagonal control matrix.

A joint transmitter-RIS beamforming scheme may be implemented. One or more of the following may apply. Referring to FIG. 17, a joint transmitter-RIS beamforming scheme may be implemented such that a precoding vector (e.g., which may be applied at the transmitter) and an off-diagonal matrix (e.g., which may be applied at the RIS) are jointly optimized.

As described herein, the routing information (e.g., off-diagonal control matrix \tilde{Θ} and/or a precoding vector w) of a RIS-aided MISO system may be determined. One or more of the following may apply. A transmitter-RIS channel matrix (e.g., a channel expressed as a channel matrix) G and/or a RIS-receiver channel vector hᵣ^{H} may be determined. Elements associated with the RIS-receiver channel vector hᵣ^{H} may be sorted as a vector hᵣ^{H}. After the transmitter-RIS channel matrix G and/or a RIS-receiver channel vector hᵣ^{H} are acquired and the channel elements are sorted as a vector h̅ᵣ^{H}, the precoding vector and/or the off-diagonal matrix may be determined (e.g., via an iterative optimization procedure). For example, prior to determining/generating the precoding vector and/or the off-diagonal matrix, an initial phase shift matrix \tilde{Θ}₀ may be determined. As described herein, the optimization procedure (e.g., to determine the precoding vector and/or the off-diagonal matrix) may include one or more alternating optimization (AO) techniques. An optimal transmission beamforming may be obtained, for example, according to MRT criterion, such as

$${w}_{l} = \frac{{( {\overline{h}}_{r}^{H} {\tilde{Θ}}_{l} G )}^{H}}{‖ {\overline{h}}_{r}^{H} {\tilde{Θ}}_{l} G ‖} ,$$

wherein l=0, 1, 2, . . . indicates the number of iterations. The elements of the vector Gwᵢ may be sorted as g̅ᵢ. The phase shift matrix may be determined based on the sorted channel vectors h̅ᵣ^{H} and/or ĝᵢ. An iteration of the optimization procedure may be interrupted based on one or more threshold. For example, an iteration of the optimization procedure may be interrupted if the number of iterations is greater than or equal to a threshold number of iterations. Also, or alternatively, an iteration of the optimization procedure may be interrupted if the increment of objective value is less than a threshold E. The precoding vector w_{L} and the phase shift control matrix \tilde{Θ}_{L} may determined/generated using the techniques described herein. For example, the phase shift control matrix \tilde{Θ}_{L} may be determine/generated at the transmitter or the RIS controller. If, for example, the phase shift control matrix \tilde{Θ}_{L} is determine/generated at the transmitter, the optimized beamforming and phase shift control matrix \tilde{Θ}_{L} may be transmitted from the transmitter to the RIS controller. Based on the precoding vector w_{L}, the transmitter may apply the precoding matrix to a signal (e.g., prior to a transmission). And based on the phase shift control matrix \tilde{Θ}_{L}, the RIS controller may perform the corresponding network routing and apply phase-shifts to impinging signals using fully-connected, multi-directional load impedance network within the RIS.

FIG. 18 illustrates an example comparison of the achievable rate (e.g., bps/Hz) based on the number of RIS elements N between a singly-connected RIS and a fully-connected, multi-directional RIS (e.g., such as the RISs illustrated in FIGS. 6 and 16). One or more of the following may apply. The example illustrated in FIG. 18 relates to a RIS-aided MISO wireless system having channel path loss exponent α=2, 2.2 and 2.4. As illustrated in FIG. 18, the achievable rate of a RIS-aided MISO wireless system (e.g., a MISO system that includes a fully-connected, multi-directional RIS) that implement off-diagonal beamforming may increase, for example, as the number of RIS elements N increases.

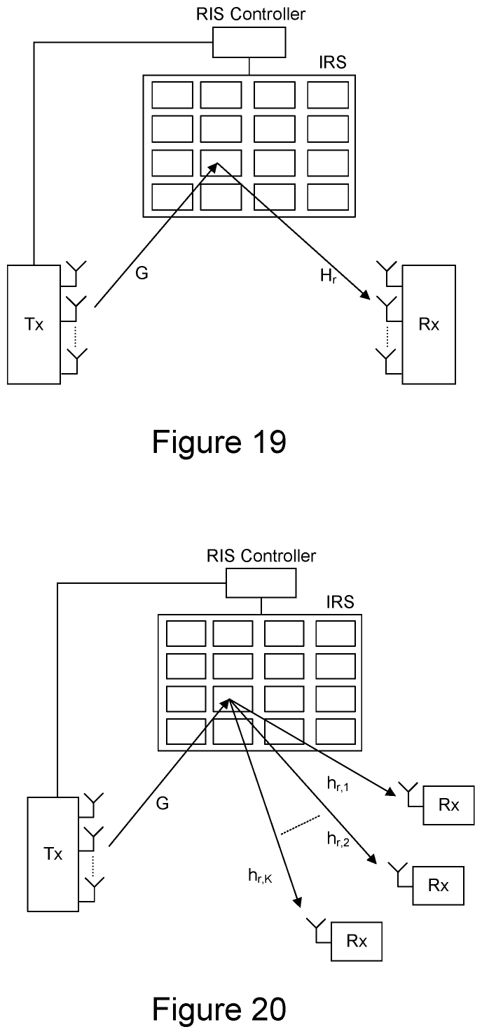

In certain scenarios, a RIS (e.g., a fully-connected, multi-directional RIS) may be implemented in a multi-input multi-output (MIMO) wireless system (e.g., referred to herein as a RIS-aided MIMO system). FIG. 19, for example, illustrates an example associated with a RIS-aided MIMO system. One or more of the following may apply. Referring to FIG. 19, an RIS-aided MIMO system may include a transmitter that includes multiple antennas, an N element RIS, and a receiver that includes multiple antennas (e.g., K receive antennas). According to embodiments, for example, in the case of the MIMO wireless system of FIG. 19, a transmitter-RIS channel and a RIS-receiver channel may be represented as matrices G and HᵣH, respectively. According to embodiments, in such a case, the transmitter/controller may compute (e.g., jointly compute) the precoding matrix and/or the off-diagonal matrix. Referring to the example illustrated in FIG. 19, a joint transmitter-RIS beamforming technique may be used where, for example, the precoding matrix (e.g., which may applied at the transmitter) and/or the off-diagonal matrix (e.g., which may be applied at the RIS, via the RIS controller) may be jointly computed.

Referring to the example illustrated in FIG. 19, the off-diagonal matrix \tilde{Θ} (i.e., which may be interchangeably referred to as an off-diagonal phase shift matrix \tilde{Θ}) and the precoding matrix W may be determined/generated. One or more of the following may apply. A matrix G associated with a transmitter-RIS channel and a matrix Hᵣ^{H}=[h_{r,1} h_{r,2} . . . h_{r,K}] associated with a RIS-receiver channel may be determined/generate. The rows in the transmitter-RIS channel matrix G may be sorted and denoted as J₁G, where J₁ represents a permutation matrix associated with the transmitter-RIS channel. The columns (e.g., entries, values, etc., in the column) in the receiver-RIS channel matrix Hᵣ^{H} may be sorted (e.g., sorted for each column vector) and denoted as Hᵣ^{H}J₂, where J₂ represent a permutation matrix associated with the receiver-RIS channel. The permutation matrix J₁ and/or the permutation matrix J₂ may each denote the permutation matrices which sort the transmitter-RIS channel vector(s) and RIS-receiver channel vector(s) in a descending or ascending order. For example, the permutation matrix J₁ and/or the permutation matrix J₂ may include value of 0 and 1, where the position of the 1's in the matrix corresponds to the sorting order. According to embodiments, the channels may be sorted according to criteria/requirements (e.g., channels amplitudes), and the positions of 1's in the permutation matrix may be determined based on the amplitudes of any of the ingress and egress channels. For example, in a case where the channel matrix G is the transmitter-RIS channel matrix, J₁G may be the sorted channel based on a certain criteria (e.g., amplitude), wherein the permutation matrix J₁ may be mapped to the coefficients of G in descending/ascending order. The off-diagonal phase shift matrix \tilde{Θ} may be determined, for example, based on to the sorted channel matrices Hᵣ^{H}J₂ and J₁G. For example, the off-diagonal phase shift matrix \tilde{Θ} may be generated using an optimization technique, such as, a non-iterative semi-definite relaxation (SDR) method (e.g., and/or any suitable and/or similar optimization method/technique). The transmission beamforming matrix W may be determined (e.g., after determining the off-diagonal phase shift matrix \tilde{Θ}), for example, using a decomposition technique, such as singular value decomposition (SVD). A power allocation matrix A may be generated, for example, using an equalization strategy, such as the water-filling algorithm, for example. The off-diagonal phase shift matrix \tilde{Θ} may be transmitted to the RIS (e.g., the RIS controller) from the transmitter. And based on the off-diagonal phase shift matrix \tilde{Θ}, the RIS controller may route signals from an ingress element to an egress element and apply phase-shift via the load impedance network within the RIS.

A fully-connected, multi-directional RIS may be implemented in a multi-user (MU) RIS-aided MIMO system (e.g., referred to herein as a MU RIS-aided MISO system). FIG. 20, for example, illustrates an example associated with a MU RIS-aided MIMO system. For example, a MU RIS-aided MIMO system may include (e.g., may be an extension of) certain features of a RIS-aided MIMO system (e.g., as described herein with respect to FIG. 19), and/or may include multiple users (e.g., receivers). Referring to the example illustrated in FIG. 20, a MU RIS-aided MIMO system may include a transmitter having multiple antennas, an N element RIS, and K single antenna receiver(s). According to embodiments, a transmitter-RIS channel matrix may be represented as G, and a receiver-RIS channel vector for the k-th receiver may be represented as h_{r,k}.

Referring to the example illustrated in FIG. 20, a transmitter-RIS channel may be represented as G, and the RIS-receiver channels (e.g., all the RIS-receivers channels) may be combined and represented as Hᵣ^{H}. As described herein, the transmitter and/or the RIS controller may compute (e.g., jointly compute) a precoding matrix and an off-diagonal beamforming matrix. Furthermore, as compared to SU MISO scenarios described herein, each receive antenna (e.g., and/or a certain number of receive elements are) in the MU scenario may be associated with a single user (e.g., receiver).

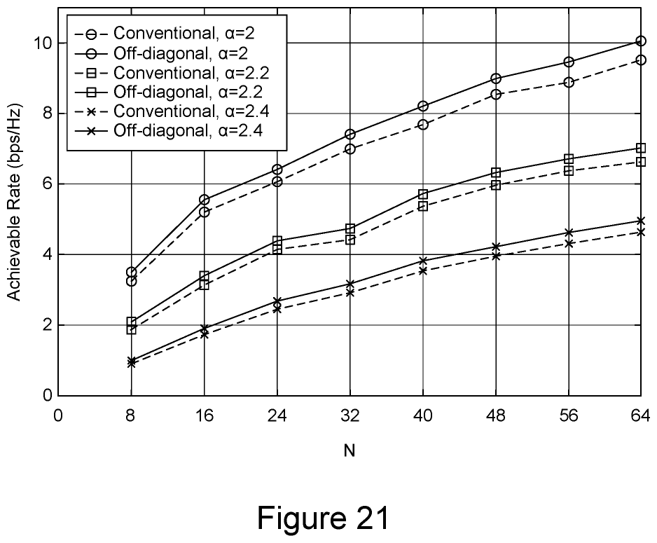

FIG. 21 illustrates an example comparison of achievable rate (e.g., bps/Hz) versus the number of RIS elements N, according to embodiments between a single-connected RIS and a fully connected, multi-directional RIS with different channel path loss exponents α=2, 2.2 and 2.4 and with K=2 users. As shown in FIG. 21, the achievable rate of a MU RIS-aided MISO wireless system (e.g., a MU MISO system that includes a fully-connected, multi-directional RIS) that implements off-diagonal beamforming may increase, for example, as the number of RIS elements N increases.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices including the constraint server and the rendezvous point/server containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed”.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments (e.g., only) and is not intended to be limiting. As used herein, when referred to herein, the terms “user equipment” and its abbreviation “UE” may mean (1) a wireless transmit and/or receive unit (WTRU), such as described infra; (2) any of a number of embodiments of a WTRU, such as described infra; (3) a wireless-capable and/or wired-capable (e.g., tetherable) device configured with, inter alia, some or all structures and functionality of a WTRU, such as described infra; (4) a wireless-capable and/or wired-capable device configured with less than all structures and functionality of a WTRU, such as described infra; or (5) the like. Details of an example WTRU, which may be representative of any WTRU recited herein.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as open terms (e.g., the term “including” should be interpreted as “including but not limited to” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or“at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to at least one of A, B, and C, etc. is used, in general such a construction is intended in the sense one having skill in the art would understand the convention (e.g., a system having at least one of A, B, and C would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer. In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A reconfigurable intelligent surface (RIS), comprising:
a plurality of elements, each of the plurality of elements configured to receive and/or transmit signals; and
a controller configured to:
receive a first feedback, the first feedback comprising channel quality information associated with a wireless channel between the RIS and at least one other device;
determine routing information for the plurality of elements of the RIS based on the first feedback, wherein the routing information comprises a mapping of ingress signals from each of the plurality of elements to egress signals from each of the other elements of the plurality of elements;
receive a first signal via a first element of the plurality of elements;
route the first signal to at least a second element of the plurality of elements based on the determined routing information, wherein a phase shift is applied to the first signal; and
transmit the phase shifted first signal via the second element.

2. The RIS of claim 1 wherein each element of the RIS is connected to each of the other elements of the RIS via a load impedance network, the load impedance network being configured to provide multi-directional connections between each of the plurality of elements.

3. The RIS of claim 1, wherein the controller is further configured to:
receive a second feedback, the second feedback comprising updated channel quality information associated with the wireless channel between the RIS and the at least one other device;
determine updated routing information based on the second feedback;
receive a second signal via the first element;
route the second signal to at least a third element of the plurality of elements based on the updated routing information, wherein a phase shift is applied to the second signal; and
transmit the phase shifted second signal via the third element.

4. The RIS of claim 3, wherein the second element and the third element are a same element.

5. The RIS of claim 1, wherein the first element and the second element are a same element.

6. The RIS of claim 1, wherein the first feedback is received from a wireless transmit/receive unit (WTRU).

7. The RIS of claim 1, wherein the first feedback is received from a network node.

8. The RIS of claim 1, wherein the at least one other device comprises a transmitter, and wherein the controller is further configured to:
determine channel coefficients associated with the wireless channel between the RIS and the transmitter; and
sort the determined channel coefficients associated with the wireless channel between the RIS and the transmitter, wherein the determined routing information is further based on the sorted channel coefficients associated with the wireless channel between the RIS and the transmitter.

9. The RIS of claim 8, wherein the at least one other device further comprises a receiver, and wherein the controller is further configured to:
determine channel coefficients associated with the wireless channel between the RIS and the receiver; and
sort the channel coefficients with the wireless channel between the RIS and the receiver, wherein the determined routing information is further based on the sorted channel coefficients associated with the wireless channel between the RIS and the receiver.

10. The RIS of claim 8, wherein the determined channel coefficients associated with the wireless channel between the RIS and the transmitter comprise amplitude components.

11. The RIS of claim 1, wherein the phase shifted first signal is transmitted via the second element towards a plurality of receivers.

12. The RIS of claim 1, wherein the determined routing information comprises an off-diagonal beamforming matrix.

13. The RIS of claim 1, wherein the phase shifted first signal is beamformed via the second element towards a receiver.

14. A wireless transmit/receive unit (WTRU), comprising a processor and memory, the processor and memory configured to:
determine channel quality information for a wireless channel associated with a reconfigurable intelligent surface (RIS);
determine a first feedback information based on the channel quality information, the first feedback comprising signal routing information and phase shift information, the signal routing information comprising an indication that a signal received via a first element of the RIS should be routed to a second element of the RIS for transmission, and the phase shift information indicating a phase shift that should be applied to the signal received via the first element of the RIS that is routed to the second element of the RIS for transmission;
transmit the first feedback to a RIS controller;
determine second feedback information, the second feedback comprising updated phase shift information, the updated phase shift information indicating an updated phase shift that should be applied in accordance with the routing information comprised in the first feedback; and
transmit the second feedback to the RIS controller.

15. The WTRU of claim 14, wherein the processor and memory are further configured to:
periodically determine updated phase shift information based on signals received from the RIS, the updated phase shift information indicating phase shifts that should be applied to the signals received via the first element; and
periodically transmit the updated phase shift information to the RIS.

16. The WTRU of claim 15, wherein the processor and memory are further configured to:
periodically determine updated signal routing information based on signals received from the RIS, the updated signal routing information comprising an indication that signals received via the first element of the RIS should be routed to a third element of the RIS for transmission; and
periodically transmit the updated signal routing information to the RIS.

17. The WTRU of claim 15, wherein the updated phase shift information is periodically transmitted to the RIS more frequently than the updated routing information to the RIS is periodically transmitted to the RIS.
